(19) United States
(12) Patent Application Publication
(10) Pub. No.: US 2005/0028073 A1
(43) Pub. Date: Feb. 3, 2005

(54) Method and system for automating workflows

(76) Inventors: Steven G. Henry, Fort Collins, CO (US); Charles A. Untulis, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,237

(22) Filed: Jul. 28, 2003

(51) Int. Cl. G06F 17/00

(52) U.S. Cl. 715/500

(57) ABSTRACT

A method of automating a workflow includes transmitting, to a multifunction peripheral, information that identifies the name and a present state of the workflow at the multifunction peripheral. The method continues with accepting, by way of a user input to the multifunction peripheral, a modification to the workflow, and inserting the modification into the workflow at the multifunction peripheral.

### BACKGROUND OF THE INVENTION

As computer networks become more and more ubiquitous in office environments, hand-carrying paper documents within the typical office is being replaced by electronic routing of these documents within the office. However, a significant number of office processes, such as court document processing and various hospital procedures, still rely on the use of paper documents. These processes may require, for example, a manual signature on a paper contract, a physician's written comments, or a physician's signature on a prescription. In other examples, paper documents may take the form of preprinted, government-required standard forms having areas for manual entry. Where office processes continue to be based on paper documents, automation of these processes can be a daunting task and requires some level of software workflow expertise.

### BRIEF DESCRIPTION OF THE DRAWINGS

FIG. 1 is a block diagram of a system for automating a workflow according to an embodiment of the invention.

FIG. 2 is a block diagram of a multifunction peripheral used in a system for automating workflows according to an embodiment of the invention.

FIG. 3 is a candidate workflow menu presented on a display of a multifunction peripheral according to an embodiment of the invention.

FIG. 4 is a partial list of tasks from a candidate workflow that has been printed and filled out by a person configuring a workflow at a multifunction peripheral according to an embodiment of the invention.

FIG. 5 shows a subset of the tasks shown in FIG. 4 as well as a scroll bar suitable for display on a multi-function peripheral or at a workstation according to an embodiment of the invention.

FIG. 6 is a flowchart for a method for automating a workflow according to an embodiment of the invention.

FIG. 7 is a flowchart for a method for modifying a workflow using a multifunction peripheral according to an embodiment of the invention.

### DESCRIPTION OF THE EMBODIMENTS

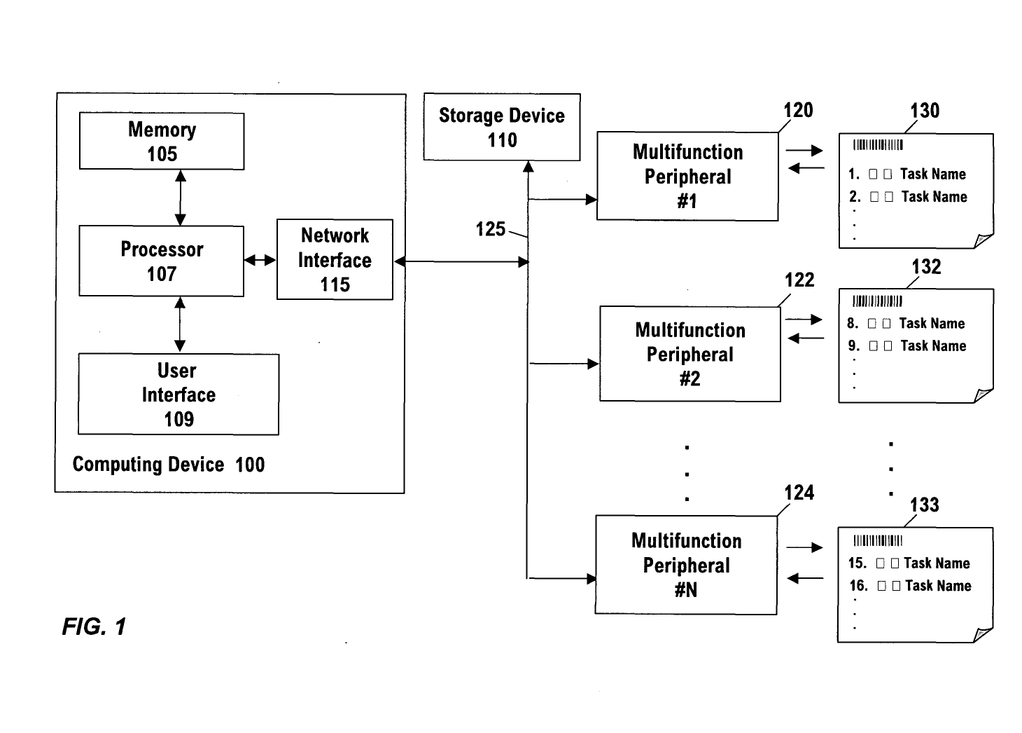

FIG. 1 is a block diagram of a system for automating a workflow according to an embodiment of the invention. The multifunction peripherals (120, 122, 124) in the system of FIG. 1 “learn” the manually performed tasks completed at the peripherals and convert these into an automated set of tasks. Thereafter, these tasks can be performed using the various multifunction peripherals of FIG. 1, thus automating the entire workflow.

In FIG. 1, computing device 100 includes memory 105, processor 107, and user interface 109. Computing device 100 may be any type of desktop computer, laptop computer, or handheld computing device. Further, computing device 100 may represent processing resources within a server that performs functions in addition to those described herein. Although not shown in FIG. 1, it is contemplated that computing device 100 includes a display that allows the user of the computing device to display information that results from processor 107 operating on data supplied to the processor from memory 105, network interface 115, and user interface 109. Additionally, memory 105 is contemplated as encompassing a wide variety of memory technologies, such as solid-state memories, optical and magnetic disks, as well as other types of volatile and non-volatile memory technologies.

Computing device 100 communicates with storage device 110, multifunction peripherals 120, 122, and 124 by way of communications network 125 and network interface 115. Communications network 125 may include conductive signal paths, such as those used with Ethernet or Intranet local area networks that operate within an enterprise. Communications network 125 may also include wireless communications capability, such as those compliant with IEEE 802.11a, b, or g, or other network protocols.

Multifunction peripherals 120, 122, and 124 represent a variety of peripheral devices that perform functions related to printing paper documents, scanning paper documents, or performing both of these functions. Further, one or more of the multifunction peripherals is contemplated as including a scanning capability that detects a simple graphic that is present at a particular location on the printed document (such as a filled-in circular “bubble”, or a square that has been filled in). Thus, multifunction peripherals 120, 122, and 124 include peripherals that print documents generated by computing device 100, as well as scanning documents that can be digitally transmitted in an electronic form along communications network 125. Multifunction peripherals 120, 122, and 124 are also contemplated as being capable of printing documents that represent instructions to the user or printing partial results relevant to a particular workflow.

In FIG. 1, although only three multifunction peripherals are shown, nothing prevents the use of as few as one or two multifunction peripherals, as well as the use of more than three of these peripherals. Further, the multifunction peripherals may be located within a single business, such as a bank or a title company, or may be located across multiple business entities that coordinate their activities to achieve a common objective, such as a mortgage loan broker, a title company, and a bank that each participate in the process of securing a real estate loan.

In the embodiment of FIG. 1, multifunction peripherals 120, 122, and 124 are used to execute the constituent parts of an automated workflow. One example of a paper document-based workflow that can be automated by the system of FIG. 1 is that of a property appraisal that may be obtained in connection with securing a residential or a commercial loan. Other examples of paper document-based workflows include hospital admissions and discharge processes, employment screening, and so forth. Thus, although the embodiment of FIG. 1 and other figures shown and described herein refer to a particular application of workflow automation, it is contemplated that a wide variety of other workflows may be automated in accordance with embodiments of the present invention.

In FIG. 1, computing device 100 is used to prepare an initial template that includes a workflow name, an ordered or unordered list of tasks that constitute the general tasks in the workflow to be automated, such as file selections that the workflow receives data from and writes data to, and so forth. The initial template thus represents a selection menu of basic tasks and also identifies relevant documents, workstations, multifunction peripherals, and users that are relevant to the overall workflow. For example, these tasks may include tasks such as “print out document just received”, or “print bar code cover sheet”. These tasks are entered into computing device 100 by way of user interface 109, which may include either one or more of a keyboard, mouse, keypad, touchpad, touch screen, and so forth. In FIG. 1, a software wizard program may be used to simplify and clarify the relevant information to be collected and displayed to the person performing the initial workflow setup.

After entering the initial template, the initial workflow setup includes specifying the first station to be involved in the workflow. An information packet that represents the workflow template is conveyed along communications network 125 to the designated multifunction peripheral, 120. In an embodiment of the invention, document 130 is printed using the multifunction peripheral and presented to a user. The document includes at least a partial list of the tasks entered into computing device 100. The user may then decide which tasks should be performed using multifunction peripheral 120 as well as select a particular ordering of the tasks performed by the multifunction peripheral.

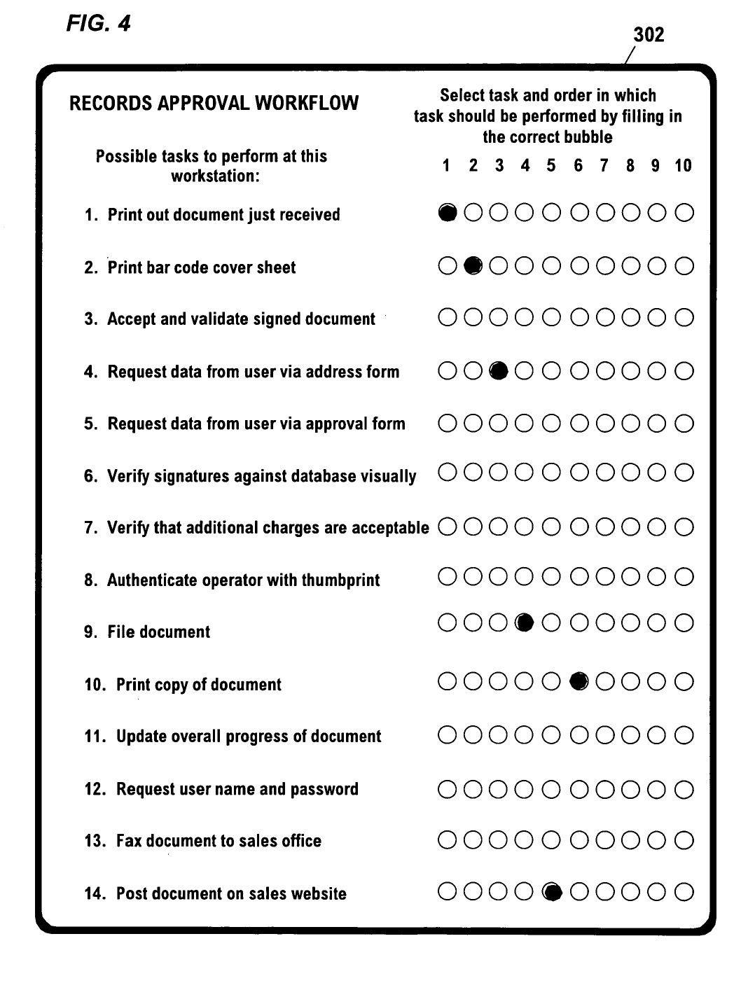

As shown in FIG. 1, document 130 may include the name of the particular task, along with two or more columns that allow the user to select whether the task is to be performed at multifunction peripheral 120. A bubble chart may be used to allow the user to indicate the order that the tasks are to be performed (such as that described in FIG. 4). The tasks identified on document 130 may include printing material with the multifunction peripheral, scanning material into the multifunction peripheral, electronically sending a digitized representation of the material, encrypting information representing the material, transmitting a facsimile of the material, receiving a facsimile of the material, and storing a representation of the material. Document 130 also includes a bar-coded label (or other machine-readable marking) that uniquely identifies the name of workflow as well as the state of the workflow at multifunction peripheral 120.

Using document 130, the user manually identifies the tasks to be performed at multifunction peripheral 120 as well as the ordering in which the tasks are performed. When the user has completed entering information into document 130, the user may scan document 130 into multifunction peripheral 120. In the embodiment of FIG. 1, multifunction peripheral 120 includes a capability to perform some level of image processing that informs the peripheral which of the tasks listed on document 130 are to be performed using peripheral 120 based on the user's entries in the columns and the bar-code label printed on document 130. FIG. 1 shows the bar-coded label in the in the upper-left portions of document 130, the label can be placed at any location on the document.

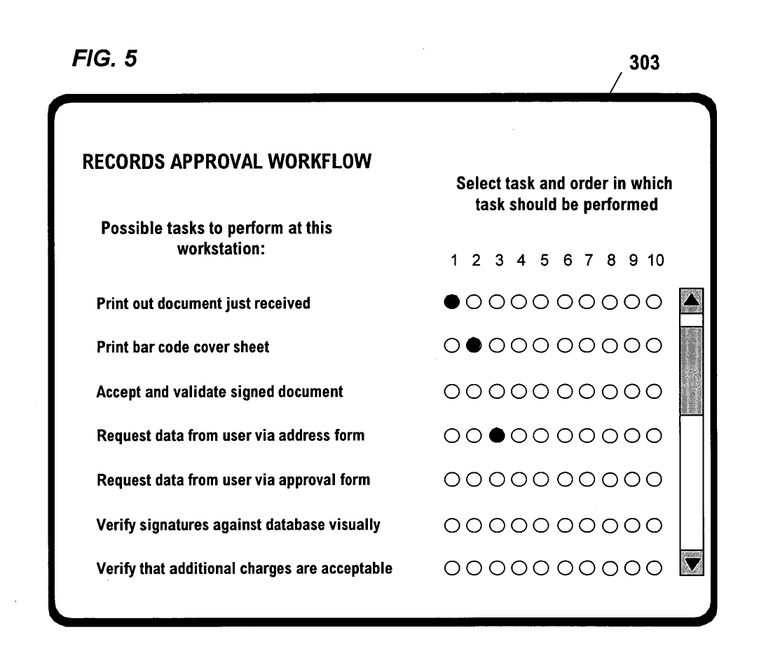

In another embodiment of the invention, document 130 includes additional columns that identify a multifunction peripheral other than peripheral 120 as well as identifying the tasks that should be performed at the other multifunction peripheral. This allows the use of a single peripheral to identify the workflow tasks performed at perhaps all of the multifunction peripherals in the system. In another embodiment, document 130 is replaced by a touch screen display interacting with the user (FIG. 5). This process collects similar information.

Returning to the embodiment of FIG. 1, after the user has completed scanning document 130 into multifunction peripheral 120, the user may complete additional interactions with the peripheral by way of user interface 109. This may include further refining selections of documents or modifying the next destination of the workflow. Then, multifunction peripheral 120 conveys the modified task list to multifunction peripheral 122 (or to the designated next multifunction peripheral). The peripheral then prints document 132, which presents a second list of the general task and data descriptions that represent possible tasks to be performed at peripheral 122. In a manner that accords with the actions performed at peripheral 120, the user modifies document 132 to identify those tasks of the workflow that are to be performed at multifunction peripheral 122 as well as the relative ordering of the tasks. Further, document 132 includes a bar-code label that identifies to peripheral 122 the names and the current state of the workflow. The user can then scan document 132 into multifunction peripheral 122, thereby identifying to the peripheral the tasks that are to be performed at peripheral 122.

In like manner, an updated task list that includes the modifications performed at each multifunction peripheral is conveyed serially to the various multifunction peripherals within the user's work environment. At each peripheral, the user is able to select which tasks of the workflow are to be performed at the particular peripheral and the order in which the tasks are performed. In one embodiment of the invention, tasks that cannot be performed at a particular multifunction peripheral may be grayed-out or not printed at all. For example, if one of the peripherals does not include a facsimile capability, tasks related to this function may not be presented. The workflow of FIG. 1 ends with task 16 performed at peripheral 124.

In an example that includes multifunction peripherals that do not possess a printing capability, such as a digital transmitter or digital sender, the user may exclude printing tasks from being performed at that particular peripheral. In another example, if a certain task in a workflow includes printing a check using Magnetic Ink Character Recognition (MICR) ink, the user may select that this task be performed using the multifunction peripheral loaded with the MICR ink. Further, if a peripheral that performs a subsequent task does not include a scanner that possesses an image processing capability nor includes a user interface capability, the user may modify the tasks performed at the peripheral by way of a previous (or subsequent) peripheral that does possess an appropriate user interface.

In some embodiments, multifunction peripherals may communicate with each other as the workflow “learning” progresses in order to streamline the selections and choices shown at any given station. In addition, the multifunction peripherals may communicate with computing device 100 in the event a problem occurs during the learning of the workflow or to provide a status update. This can alert the setup administrator in the event that a corrective action is required.

When the user has completed modifying a workflow, the user-modified task list that represents the workflow can be stored in memory 105 of computing device 100. Alternatively, the appropriate portions of the workflow can be stored in multifunction peripherals 120, 122, and 124. In this embodiment, the individual peripherals store those tasks performed at the respective peripheral.

In another embodiment, computing device 100 is not present. In such an embodiment, storage device 110 may have a preloaded template that includes the various tasks of the particular workflow. At each of peripherals 120, 122, and 124, the user may retrieve the appropriate workflow from storage device 110, thereby allowing the workflow to be modified at the peripheral.

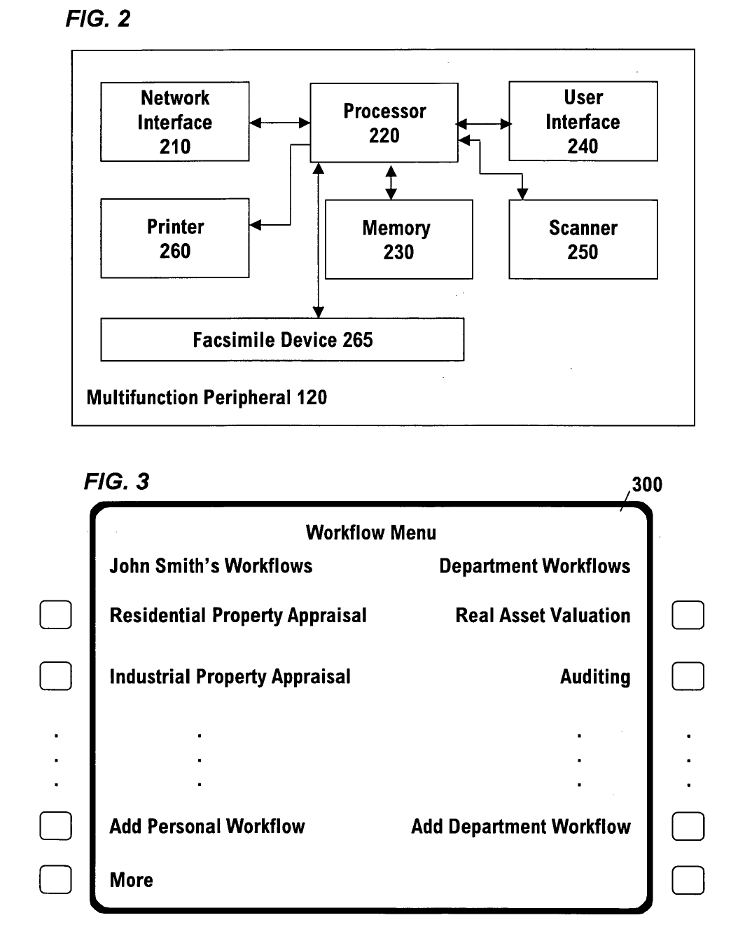

FIG. 2 is a block diagram of a multifunction peripheral used in a system for automating workflows according to an embodiment of the invention. In the embodiment of FIG. 2, multifunction peripheral 120 includes network interface 210, which provides communications along communications network 125 (of FIG. 1). Peripheral 120 also includes processor 220, and memory 230, which stores a list of the tasks of the workflow. Included also are user interface 240, scanner 250, and printer 260. Peripheral 120 includes facsimile device 265 that allows the user to transmit and receive facsimile copies of printed documents.

In the embodiment of FIG. 2, user interface 240 includes a display that presents workflow tasks to the user and accepts inputs from the user, such as the touch screen inputs that are used to select the order in which the workflow tasks are to be performed. User interface 240 may also include a keypad, integral or external keyboard or other input device as well as security and authentication measures, such as a fingerprint reader that authenticates the user by way of the user's finger or thumbprint. User interface 240 may also include a badge reader, signature pad, or other identity-verification scheme. Processor 220 controls the operations of the peripheral, as well as performing image-processing functions on paper documents input into the peripheral by way of scanner 250.

It is contemplated that the multifunction peripheral of FIG. 2 is capable of performing more than one workflow, such as will be discussed in connection with FIG. 3. For example, in the event that the peripheral of FIG. 2 is located in a financial institution, the peripheral may perform a variety of workflows related to personal savings and checking account management, stock transactions, real estate loans, and so forth. Each of these workflows may be uniquely identified and may be associated with a particular individual or group of individuals employed at the financial institution. Further, each instantiation of a particular workflow, such as a real estate loan application for a specific property, may carry an identifier selected by a particular individual at the financial institution. In addition, in the event that two or more individuals have selected the same identifier, such as “Benton Heights Development”, processor 220 includes the necessary logic to deconflict one workflow associated with employee “A” from a similar workflow associate with employee “B”.

FIG. 3 is a candidate workflow menu presented on a display of a multifunction peripheral according to an embodiment of the invention. In FIG. 3, workflow menu 300 is presented after the user named John Smith has identified himself to the peripheral. In the left column of workflow menu 300, are the titles of the workflows for which John Smith is responsible. These workflows include the residential property appraisal, industrial property appraisal, and so forth. Near the bottom of workflow menu 300, “Add Personal Workflow” allows the user (John Smith) to retrieve a workflow or a template for a workflow that is not already listed. On the right-hand column of workflow menu 300, workflows that perhaps pertain to the department in which John Smith works are also listed. These workflows include, but are not limited to, “Real Asset Valuation”, “Auditing”, and so forth. At the lower right side of workflow menu 300, the display provides the capability to access a template for a workflow that is not already displayed.

FIG. 4 is a partial list of tasks from a candidate workflow that has been printed and filled out by a person configuring a workflow at a multifunction peripheral according to an embodiment of the invention. The tasks listed in FIG. 4 can pertain to any type of general business-related workflow involving various activities that include printing documents, validating a signature, authenticating a user, filing a document, and so forth. FIG. 4 also includes an entry to select the ordering of tasks in the event that several tasks need to be performed at a particular peripheral. The hardcopy printout of FIG. 4 may also show workflow tasks performed at a previous or subsequent multifunction peripheral. As previously mentioned, this allows the user to make additions, deletions, and other modifications to tasks performed using other multifunction peripherals that perform the workflow.

In FIG. 4, the multifunction peripheral has been placed in a training mode that allows the user to modify the tasks of the workflow performed at the particular peripheral. As previously mentioned, the ability to place the peripheral into a mode in which the workflow tasks can be modified, added, or deleted may require the authentication of the user to establish that the user is indeed authorized to make changes to the workflow. In the context of FIG. 4, a user may wish to move the task “Request user name and password” (task 12) so that this task is performed prior to any other. To bring about this modification, the user need only fill in the bubble in the “1” column adjacent to the task name to indicate that this task is to be performed first. The printed document is then scanned into the multifunction peripheral where processor 220 (of FIG. 2) determines the presence of the filled-in bubble and proceeds to the next task in the workflow.

FIG. 5 shows a subset of the tasks shown in FIG. 4 as well as a scroll bar suitable for display on a multi-function peripheral or at a workstation according to an embodiment of the invention. The addition of the scroll bar to the display more closely resembles the manner in which the task list would be displayed on a contemporary multifunction peripheral having a smaller-sized display. In the example of FIG. 5, a touch screen is used to select the order in which the tasks are to be performed. Although not shown in the Figure, a “reorder” button may be included that functions to display the tasks in the order in which they are to be performed.

FIG. 5 may also include a selection to append or prepend tasks to the current list of tasks being performed at the present multifunction peripheral. Thus, in the event that either a previous or a subsequent multifunction peripheral becomes inoperative, the tasks performed by the currently inoperative peripheral can be directed to be performed at the present peripheral. This can be especially useful in that a particular workflow, which may involve the use of several peripherals performing the workflow's tasks in a serial fashion, can be made fault tolerant such that the loss of a single peripheral need not stall the entire workflow.

FIG. 5 further can also include a selection to reorder the displayed tasks as required. The rearranged workflow tasks can then be saved and performed in the rearranged order the next time the workflow is performed. In another example, the display of the multifunction peripheral may simply present information, such as the document's file name, and solicits an input from the user to indicate that the user approves or has verified the correctness of the displayed information.

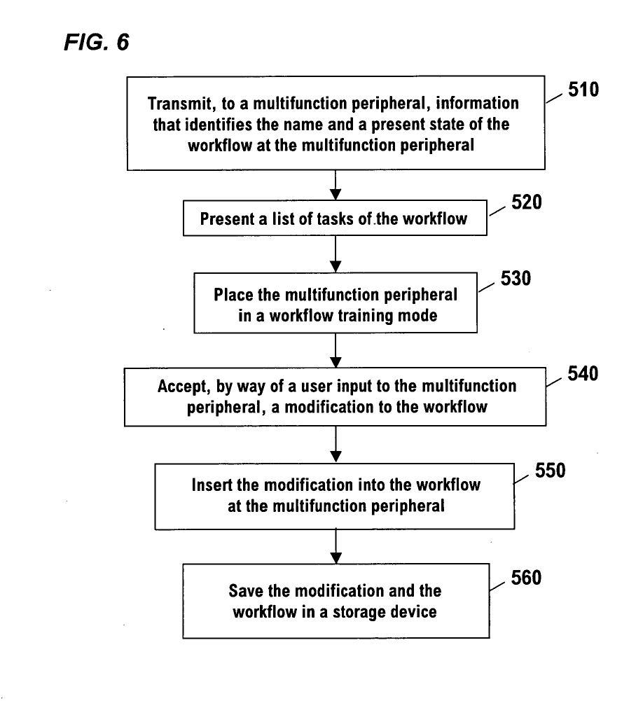

FIG. 6 is a flowchart for a method for automating a workflow according to an embodiment of the invention. The multifunction peripheral discussed in reference to FIG. 2 is suitable for performing the method of FIG. 6. The method begins at step 510, in which information that identifies the name and a present state of the workflow at the multifunction peripheral are transmitted to a multifunction peripheral. At step 520, a list of workflow tasks is presented to the user of the multifunction peripheral. The list of tasks may correspond to tasks that have been previously performed in the workflow, such as at a previous peripheral, or the list may pertain to tasks that have not yet been performed in the workflow. Step 520 can include presenting the name or some other identifier of the workflow and the present state of the workflow. Step 520 may include presenting a printed list, in which the user input to the multifunction peripheral includes the user marking entries on the printed list, such as is described with reference to FIGS. 1 and 4.

At step 530, the multifunction peripheral is placed in a workflow training mode that allows the peripheral to accept changes to the workflow, perhaps after authenticating the user by way of the user entering a password, signing on a signature pad, placing finger or thumb on a fingerprint reading device, or entering a personal identification number into the peripheral. At step 540, the modification to the workflow is accepted. Step 540 may include the user entering input to the multifunction peripheral using a touch screen, a keyboard, or perhaps by marking on a bar-coded, printed document such as document 130 of FIG. 1. At step 550, the modification is inserted into the workflow at the multifunction peripheral.

The method continues at step 560, in which the modification and the workflow are saved in a storage device. In step 560, the actual modification may include adding a task to the workflow, adding user input to one or more of the multifunction peripherals that perform the workflow, and so forth. These inputs may be made in response to the multifunction peripheral printing a document, the user entering information onto the printed document, and then scanning the document into the peripheral.

In some embodiments of the invention, a method of automating a workflow may include only the steps of transmitting, to a multifunction peripheral, information that identifies the name and a present state of the workflow at the multifunction peripheral (step 510), the multifunction peripheral accepting, by way of a user input, a modification to the workflow (step 540), and the multifunction peripheral inserting the modification into the workflow step (550).

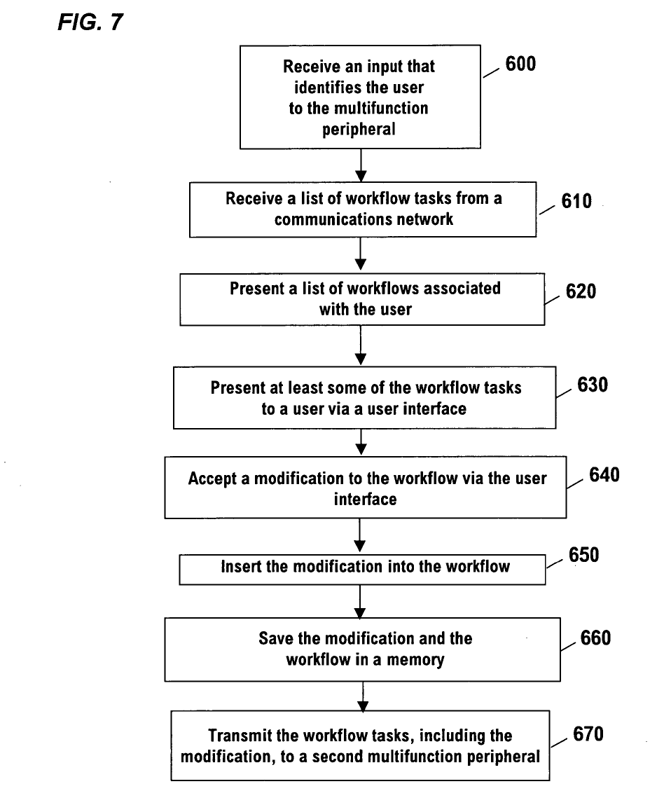

FIG. 7 is a flowchart for a method for modifying a workflow using a multifunction peripheral according to an embodiment of the invention. The multifunction peripheral FIG. 2 is suitable for performing the method of FIG. 7. The method of FIG. 7 begins at step 600, in which the multifunction peripheral receives an input that identifies the user. In step 600, the input may include receiving a password, a personal identification number, a fingerprint or thumbprint, or receiving other information that identifies and authenticates the user. At step 610, a list of workflow tasks is received from a communications network, such as network 125 of FIG. 1.

At step 620, a list of workflows associated with the user is presented, perhaps by way of a display located on the peripheral. In step 630 at least some of the workflow tasks are presented to the user by way of a user interface. At step 640, the peripheral accepts a modification to the workflow by way of the user interface. In response to receiving the modification, the peripheral inserts the modification into the workflow at step 650. At step 660, the peripheral saves the modification and the workflow in a memory. At step 670, workflow tasks, including the modification, are transmitted to a second multifunction peripheral.

In some embodiments of the invention, only a subset of the steps of FIG. 7 may be necessary. For example, some embodiments of the invention may include a method for modifying a workflow in a multifunction peripheral that includes receiving a list of workflow tasks from a communications network (610), presenting at least some of the workflow tasks to a user via a user interface (630), accepting a modification to the workflow via the user interface (640), inserting the modification into the workflow (650).

In conclusion, while the present invention has been particularly shown and described with reference to the foregoing preferred and alternative embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

1. A method of automating a workflow, comprising:
transmitting, to a multifunction peripheral, information that identifies a name and a present state of the workflow at the multifunction peripheral;
the multifunction peripheral accepting, by way of a user input, a modification to the workflow; and
the multifunction peripheral inserting the modification into the workflow.

2. The method of claim 1, additionally comprising saving the modification and the workflow in a storage device.

3. The method of claim 1, wherein the modification is the addition of a task to the workflow.

4. The method of claim 1, wherein the modification is the deletion of a task to the workflow.

5. The method of claim 1, wherein the modification pertains to receiving a user input at the multifunction peripheral.

6. The method of claim 1, wherein the modification pertains to printing a document at the multifunction peripheral.

7. The method of claim 1, wherein the modification pertains to one of receiving and transmitting a facsimile of a document at the multifunction peripheral.

8. The method of claim 1, wherein the modification pertains to scanning a document into the multifunction peripheral.

9. The method of claim 1, wherein the modification pertains to a task that is to be performed at a multifunction peripheral that performs a subsequent task in the workflow.

10. The method of claim 1, wherein the modification pertains to a task that is to be performed at a multifunction peripheral that performs a previous task in the workflow.

11. The method of claim 1, further comprising the step of presenting a list of tasks of the workflow.

12. The method of claim 11, wherein at least one task of the list of tasks corresponds to a task that has been previously performed in the workflow.

13. The method of claim 11, wherein at least one task of the list of tasks corresponds to a task that has not yet been performed in the workflow.

14. The method of claim 1, further comprising the user placing the multifunction peripheral into a workflow-training mode.

15. The method of claim 1, wherein the name and the present state of the workflow are presented to a user by way of a printed list, and wherein the user input to the multifunction peripheral comprises the user marking entries on the printed list.

16. The method of claim 1, wherein the printed list includes a bar-coded label that identifies the printed list and the present state of the workflow to the multifunction peripheral.

17. A system for automating tasks of a workflow, comprising:
a computing device that accepts inputs identifying at least some of the tasks of the workflow;
a plurality of multifunction peripherals that perform the at least some tasks of the workflow, wherein
the plurality of the multifunction peripherals accepts inputs that modify the workflow.

18. The system of claim 17, wherein the computing device includes a memory that stores the workflow modified by the accepted inputs.

19. The system of claim 17, further comprising a storage device that stores the workflow modified by the accepted inputs.

20. The system of claim 17, wherein the tasks of the workflow include printing material using at least one of the plurality of multifunction peripherals.

21. The system of claim 17, wherein the tasks of the workflow include scanning material into at least one of the plurality of the multifunction peripherals.

22. The system of claim 17, wherein the inputs that modify the workflow are user inputs that add a task to the workflow.

23. The system of claim 22, wherein the task added to the workflow is a request for a user input at one of the plurality of multifunction peripherals.

24. The system of claim 22, wherein the task added to the workflow is a task that instructs one of the plurality of the multifunction peripherals to print a page.

25. The system of claim 22, wherein the task added to the workflow is a task that instructs one of the plurality of the multifunction peripherals to accept a page that is scanned into one of the plurality of the multifunction peripherals.

26. The system of claim 17, wherein the inputs that modify the workflow are user inputs that delete a task of the workflow.

27. The system of claim 17, wherein the inputs that modify the workflow are in the form of a list having machine-readable markings that identify a name and a present state of the workflow and at least some of the tasks of the workflow.

28. The system of claim 17, wherein the inputs that modify the workflow are in the form of touch screen inputs received by way of a user interface of one of the plurality of multifunction peripheral.

29. In a multifunction peripheral,
a method for modifying a workflow, comprising:
receiving a list of workflow tasks from a communications network;
presenting at least some of the workflow tasks to a user via a user interface;
accepting a modification to the workflow via the user interface; and
inserting the modification into the workflow.

30. The method of claim 29, further comprising the step of receiving an input that identifies the user to the multifunction peripheral, the receiving an input step being performed prior to the receiving a list of workflow tasks step.

31. The method of claim 29, additionally comprising the step of saving the modification and the workflow in a memory.

32. The method of claim 29, additionally comprising the step of transmitting the workflow tasks, including the modification, to a second multifunction peripheral.

33. The method of claim 29, wherein the communications network connects the multifunction peripheral to a computing device that transmits the list of workflow tasks to the multifunction peripheral.

34. The method of claim 29, wherein the workflow represents a process that includes one of printing material with the multifunction peripheral, scanning material into the multifunction peripheral, sending an electronic message, encrypting information representing the material, transmitting a facsimile of the material, receiving a facsimile of the material, and storing information representing the material.

35. The method of claim 29, wherein the user interface includes at least one of a badge reader, a fingerprint reading device, a thumbprint-reading device, and a signature pad.

36. A system for automating a workflow, comprising:
means for accepting a list of tasks of the workflow, the tasks of the workflow being performed by at least one multifunction peripheral;
means for presenting to a user, by way of the at least one multifunction peripheral, at least some of the tasks of the workflow; and
means for accepting from the user a change to the order of the tasks performed by the multifunction peripheral.

37. The system of claim 36, wherein the means for accepting the list of tasks further comprises a network interface that permits the at least one multifunction peripheral to communicate with a second multifunction peripheral.

38. The system of claim 36, wherein the means for presenting the at least some of the tasks of the workflow is a display located on the peripheral.

39. The system of claim 36, wherein the means for accepting a change to the order of the tasks performed by the multifunction peripheral includes a means for detecting that a bubble has been filled in at a particular location.

40. The system of claim 36, wherein the means for accepting a change to the order of the tasks performed by the multifunction peripheral includes a touch screen.
